(19) United States
(12) Patent Application Publication
(10) Pub. No.: US 2008/0190768 A1
(43) Pub. Date: Aug. 14, 2008

(54) Gas sensor having extra high accuracy and reliability and method of manufacturing the same

(75) Inventors: Takehito Kimata, Kariya-shi (JP); Masanobu Yamauchi, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/068,959

(22) Filed: Feb. 13, 2008

(30) Foreign Application Priority Data
Feb. 14, 2007 (JP) 2007-032929

(51) Int. Cl. G01N 27/409

(52) U.S. Cl. 204/429; 427/453

(57) ABSTRACT

A gas sensor includes a sensing element, a housing, a metal cover, and an oxide layer. The sensing element generates a signal indicative of an oxygen concentration in a measurement gas. The housing holds therein the sensing element with a portion of the sensing element protruding outside of the housing. The metal cover surrounds the portion of the sensing element and is to be exposed the measurement gas. The metal cover has formed therein a gas passage through which the sensing element is also to be exposed to the measurement gas. The oxide layer is formed on at least a surface of the metal cover. With the oxide layer, during operation, at least the metal cover is prevented from being oxidized by the oxygen contained in the measurement gas. Consequently, the oxygen concentration in the measurement gas can be accurately determined based on the signal generated by the sensing element.

### CROSS-REFERENCE TO RELATED APPLICATION

This application is based on and claims priority from Japanese Patent Application No. 2007-32929, filed on Feb. 14, 2007, the content of which is hereby incorporated by reference in its entirety into this application.

### BACKGROUND OF THE INVENTION

1. Technical Field of the Invention

The present invention relates to gas sensors, which include a sensing element for generating a signal indicative of the oxygen concentration in a measurement gas (i.e., a gas to be measured), and methods of manufacturing such gas sensors.

More particularly, the invention relates to a gas sensor, which is disposed in a passage of the exhaust gas from an internal combustion engine of a motor vehicle downstream of a three-way catalyst, and a method of manufacturing the gas sensor.

2. Description of the Related Art

Conventionally, as shown in FIG. 8, a gas sensor 20 is disposed in a passage 432 of the exhaust gas from an internal combustion engine 40 of a motor vehicle. The gas sensor 20 includes a sensing element that generates a signal indicative of the oxygen concentration in the exhaust gas.

An Engine Control Unit (ECU) 50 determines, based on the signal generated by the sensing element, the air/fuel ratio, the NOx concentration in the exhaust gas, and so on. The ECU 50 further determines the current operating condition of the engine 40 on the basis of signals respectively indicative of an accelerator position Ac, an engine speed Ne, and an engine cooling water temperature Tw. Then, the ECU 50 controls the combustion of the engine 40 by controlling, for example, the injection time of a fuel injector 440, so as to bring the air/fuel ratio to a value that is optimal in the current operating condition.

In practical use, the ECU 50 controls the engine 40 to selectively operate in two different modes. One mode is a lean combustion mode in which the air/fuel ratio is made high so as to improve fuel economy; the other is a rich combustion mode in which the air/fuel ratio is made low so as to facilitate acceleration.

Moreover, in the passage 432, there is provided a three-way catalyst 30 for purifying the exhaust gas. In the three-way catalyst 30, harmful components of the exhaust gas (i.e., nitrogen oxides, hydrocarbon, and carbon monoxide) are converted into harmless components (i.e., nitrogen, water, and carbon dioxide) through the following oxidation and reduction reactions:

2NOx→N2+xO2 (reduction of nitrogen oxides);

4CmHn+(4m+n)O2→4mCO2+2nH2O (oxidation of hydrocarbon); and

2CO+O2→2CO2 (oxidation of carbon monoxide).

In a passage 433 of the exhaust gas behind the three-way catalyst 30, there is disposed a gas sensor 20b. The gas sensor 20b includes a sensing element that generates a signal indicative of the oxygen concentration in the exhaust gas downstream of the three-way catalyst 30; the signal is then used by the ECU 50 for correction of the air/fuel ratio, deterioration detection of the three-way catalyst 30, and control of an exhaust gas purification device 60 arranged downstream of the gas sensor 20b.

FIG. 9A shows changes with the air/fuel ratio in the concentrations of components of the exhaust gas upstream of the three-way catalyst 30. It can be seen from FIG. 9A that the concentrations of unburnt hydrocarbon (i.e., the total hydrocarbon concentration THC) and carbon monoxide (CO) are high when the air/fuel mixture is rich, whereas those of oxygen (O₂) and nitrogen oxides (NOx) are high when the same is lean.

FIG. 9B shows changes with the air/fuel ratio in the concentrations of components of the exhaust gas downstream of the three-way catalyst 30. It can be seen from FIG. 9B that in the vicinity of the stoichiometric air fuel ratio (i.e., λ=1), the three-way catalyst 30 works most efficiently to purify the exhaust gas.

However, in practical use, as described above, the ECU 50 changes the operation of the engine 40 between the lean combustion and rich combustion modes. Consequently, the concentrations of components of the exhaust gas downstream of the three-way catalyst 30 accordingly change with the air/fuel ratio.

Further, the concentrations of some components of the exhaust gas downstream of the three-way catalyst 30 are lowered to about 1/10 of those upstream of the three-way catalyst 30. In particular, the concentration of oxygen downstream of the three-way catalyst 30 becomes almost zero in the vicinity of the stoichiometric air fuel ratio.

Accordingly, it is required for the gas sensor 20b disposed downstream of the three-way catalyst 30 to have extra high accuracy, so as to allow the correction of the air/fuel ratio, deterioration detection of the three-way catalyst 30, and control of the exhaust gas purification device 60 to be reliably performed.

For example, U.S. Pat. No. 6,182,498 B1 discloses an oxygen sensor that is to be disposed downstream of an exhaust gas purifying catalyst. In this oxygen sensor, the amount of gas to be passed through a gas flow passage formed in a protective cover is limited so as to suppress the influence of unburnt hydrocarbon on the output voltage of the sensor.

When the gas sensor 20b is of a conventional type and thus does not posses extra high accuracy, it outputs a voltage signal whose wave form is shown in FIG. 10A.

In FIG. 10A, there are shaded regions in which the air/fuel mixture is actually lean, but is falsely indicated by the voltage signal output from the gas sensor 20b as being rich. Hereinafter, such regions will be referred to as false rich indication regions.

Further, when the ECU 50 detects the concentration of NOx in the exhaust gas based on the voltage signal output from the gas sensor 20b, the detected concentration of NOx is as shown in FIG. 10B.

In FIG. 10B, there are shaded regions in which the concentration of NOx is actually high, but is falsely detected as being extremely low. Hereinafter, such regions will be referred to as false detection regions.

Due to the false rich indication by the voltage signal output from the gas sensor 20b, the ECU 50 cannot suitably control the combustion of the engine 40. More specifically, when the air/fuel mixture is lean, the ECU 50 is supposed to decrease the air/fuel ratio and control the exhaust gas purification device 60 to absorb more NOx, thereby decreasing the concentration of NOx. However, due to the false rich indication by the voltage signal output from the gas sensor 20b, the ECU 50 instead increases the air/fuel ratio and controls the exhaust gas purification device 60 to absorb less NOx, thus increasing the concentration of NOx in the exhaust gas.

The above-described problem of false rich indication tends to occur especially when the gas sensor 20b is new.

### SUMMARY OF THE INVENTION

The present invention has been made in view of the above-mentioned problem.

It is, therefore, a primary object of the present invention to provide a gas sensor, which has extra high accuracy and reliability, and a method of manufacturing the gas sensor.

According to one aspect of the present invention, there is provided a gas sensor which includes a sensing element, a housing, a metal cover, and an oxide layer.

The sensing element generates a signal indicative of an oxygen concentration in a measurement gas. The housing holds therein the sensing element with a portion of the sensing element protruding outside of the housing. The metal cover surrounds the portion of the sensing element and is to be exposed the measurement gas. The metal cover has formed therein a gas passage through which the sensing element is also to be exposed to the measurement gas. The oxide layer is formed on at least a surface of the metal cover.

With the oxide layer, during operation of the gas sensor, at least the metal cover is prevented from being oxidized by the oxygen contained in the measurement gas. In other words, there is no oxygen to be consumed for oxidizing the metal cover.

Consequently, it is possible to accurately determine the oxygen concentration in the measurement gas based on the signal generated by the sensing element, without causing the false rich indication problem. Accordingly, the gas sensor according to the invention possesses extra high accuracy and reliability.

According to a further implementation of the invention, the measurement gas is exhaust gas from an internal combustion engine. The gas sensor is disposed, in a passage of the exhaust gas, downstream of a three-way catalyst for purifying the exhaust gas.

On the downstream side of the three-way catalyst, the oxygen concentration in the exhaust gas is extremely low. However, by using the gas sensor according to the invention, it is still possible to accurately determine the oxygen concentration.

In the gas sensor, the sensing element includes: a solid electrolyte body that is conductive of oxygen ion and has first and second surfaces; a measurement electrode that is provided on the first surface of the solid electrolyte body so as to be exposed to the measurement gas; and a reference electrode that is provided on the second surface of the solid electrolyte body so as to be exposed to a reference gas introduced into the gas sensor. The oxide layer is also formed on a surface of the measurement electrode of the sensing element.

With the above configuration, during operation of the gas sensor, there is no oxygen consumed for oxidizing the measurement electrode. Accordingly, the accuracy and reliability of the gas sensor are further enhanced.

According to another aspect of the present invention, there is provided a method of manufacturing a gas sensor comprising: preparing a sensing element for generating a signal indicative of an oxygen concentration in a measurement gas; preparing a housing; assembling the sensing element and housing together so that the sensing element is held in the housing with a portion thereof protruding outside of the housing; preparing a metal cover that is to be exposed to the measurement gas and has formed therein a gas passage; assembling the metal cover to the sensing element and housing so that the metal cover surrounds the portion of the sensing element but allows the sensing element to be exposed to the measurement gas through the gas passage; and forming an oxide layer on at least a surface of the metal cover through a heat treatment in an atmosphere containing oxygen.

Using the above method, it is possible to easily form the oxide layer on at least the surfaces of the metal cover. With the oxide layer, during operation of the gas sensor, at least the metal cover is prevented from being oxidized by the oxygen contained in the measurement gas. Consequently, it is possible to accurately determine the oxygen concentration in the measurement gas based on the signal generated by the sensing element, without causing the false rich indication problem.

Moreover, during the step of forming the oxide layer, residues of organic compounds used in the other steps can be completely eliminated from the gas sensor. Consequently, there will be no VOC (Volatile Organic Compounds) generated during operation of the gas sensor, thus reliably preventing occurrence of the false rich indication due to VOC.

To more easily and reliably form the oxide layer, the atmosphere preferably contains 3% or more oxygen.

For the same purpose, the heat treatment is preferably performed at a temperature not lower than a temperature of the measurement gas or 600° C.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is a partially cross-sectional view showing the overall configuration of a gas sensor according to the first embodiment of the invention;

FIG. 2 is a graphical representation showing the results of a comparative test between the gas sensor of FIG. 1 and a conventional gas sensor;

FIG. 3 is a schematic view showing the disposition of the gas sensor of FIG. 1 in an exhaust system of a motor vehicle.

FIG. 4A is a wave form chart showing a voltage signal output from the gas sensor of FIG. 1;

FIG. 4B is a graphical representation illustrating an accurate detection of the NOx concentration in the exhaust gas in the exhaust system of FIG. 3.

FIG. 5 is a graphical presentation showing the results of an experimental investigation for solving the problem of false rich indication;

FIG. 6 is a flow chart illustrating a method of manufacturing the gas sensor of FIG. 1;

FIG. 7 is a partially cross-sectional view showing the overall configuration of a gas sensor according to the second embodiment of the invention;

FIG. 8 is a schematic view showing the disposition of the conventional gas sensor in an exhaust system of a motor vehicle.

FIG. 9A is a graphical representation showing the concentrations of components of the exhaust gas upstream of a three-way catalyst in the exhaust system of FIG. 8;

FIG. 9B is a graphical representation showing the concentrations of components of the exhaust gas downstream of the three-way catalyst in the exhaust system of FIG. 8;

FIG. 10A is a wave form chart showing a voltage signal output from the conventional gas sensor; and

FIG. 10B is a graphical representation illustrating a false detection of the NOx concentration in the exhaust gas in the exhaust system of FIG. 8.

### DESCRIPTION OF PREFERRED EMBODIMENTS

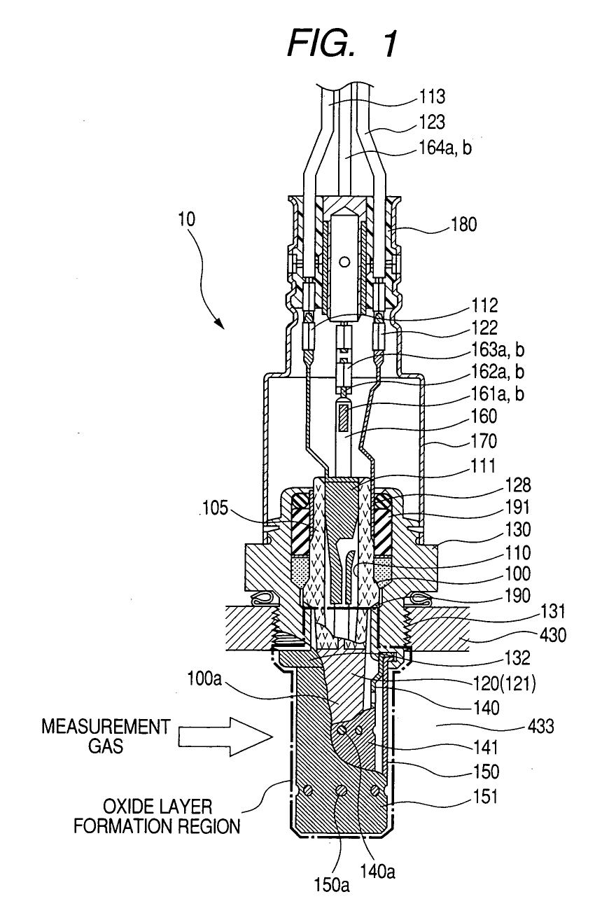

Preferred embodiments of the present invention will be described hereinafter with reference to FIGS. 1-7.

It should be noted that, for the sake of clarity and understanding, identical components having identical functions in different embodiments of the invention have been marked, where possible, with the same reference numerals in each of the figures.

### First Embodiment

FIG. 1 shows the overall configuration of a gas sensor 10 according to the first embodiment of the invention.

As shown in FIG. 1, the gas sensor 10 includes a sensing element 100, a housing 130 for fixing the sensing element 100 in a passage 443 of a measurement gas (i.e., a gas to be measured), inner and outer covers 140 and 150 for protecting the sensing element 100 in the passage 433, and a ceramic heater 160 for heating the sensing element 100. The gas sensor 10 further includes oxide layers 121, 132, 141, and 151 formed on surfaces of those parts of the gas sensor 10 which are exposed to the measurement gas and enclosed with a chain line in FIG. 1 as an oxide layer formation region of the gas sensor 10.

The sensing element 100 is configured to generate a voltage signal indicative of the oxygen concentration in the measurement gas.

Specifically, the sensing element 100 includes a solid electrolyte body 105 that is conductive of oxygen ion and shaped like a cup (or a bottomed tube). The solid electrolyte body 105 is made of, for example, a ceramic material including zirconia.

On the inner and outer surfaces of the solid electrolyte body 105, there are respectively provided a reference electrode layer 110 and a measurement electrode layer 120.

The reference and measurement electrode layers 110 and 120 are made of platinum and formed on the respective surfaces by electroless plating or thick-film printing. The reference electrode layer 110 is exposed to a reference gas (e.g., air) that is introduced into the solid electrolyte body 105 from the open end; the measurement electrode layer 120 is exposed to the measurement gas introduced thereto through the metal covers 140 and 150.

Further, on the surface of the measurement electrode layer 120, there is formed the oxide layer 121.

The housing 130 is tubular in shape and made of a metal such as stainless steel. The housing 130 holds therein the sensing element 100 with a sensing portion 100a of the sensing element 100 protruding outside of the housing 130.

The inner and outer covers 140 and 150 are cup-shaped and made of a metal such as stainless steel. The inner and outer covers 140 and 150 are fixed to the housing 130, so as to enclose that sensing portion 100a of the sensing element 100 which protrudes outside of the housing 130. The inner and outer covers 140 and 150 respectively have through-holes 140a and 150a, through which the measurement gas is introduced to the sensing portion 100a of the sensing element 100. In other words, the through-holes 140a and 150a together form a gas passage through which the sensing element 100 is exposed to the measurement gas.

Further, on the entire inner and outer surfaces of the inner cover 140, there is formed the oxide layer 141; on the entire inner and outer surfaces of the outer cover 150, there is formed the oxide layer 151.

The ceramic heater 160 is provided for quick activation of the sensing element 100. The ceramic heater 160 is held in the sensing element 100 by a heater holder 111 that is made of a metal.

The ceramic heater 160 includes a heating element (not shown) arranged closer to the lower end of the heater 160. For powering the heating element, heater electrodes 161a and 161b are provided on the surface of the ceramic heater 160 closer to the upper end of the heater 160.

To the heater electrodes 161a and 161b, there are respectively connected, via connectors 163a and 163b, power lines 164a and 164b that are further connected to an external power source.

The heater holder 111, while holding the ceramic heater 160, makes up a reference electrode terminal connected to the reference electrode layer 110. The heater holder 111 is further connected, via a connector 112, to a signal line 113 for outputting the voltage signal generated by the sensing element 100 to an external control apparatus.

On the other hand, a measurement electrode terminal 128 is embedded in the outer surface of the solid electrolyte body 105 in the vicinity of the open end; the terminal 128 is connected to the measurement electrode layer 120. The measurement electrode terminal 128 is further connected, via a connector 122, to a signal line 123 for outputting the voltage signal to the external control apparatus.

The sensing element 100 is fixed in the housing 130 via a seal member 190 and packing 191, by means of which leakage of the measurement gas through the gas sensor 10 is prevented.

The housing 130 has a threaded portion 131 formed on a lower outer periphery thereof. The inner and outer covers 140 and 150 are fixed to the lower end of the housing 130 by crimping. The threaded portion 131 of the housing 130 is fastened into a wall defining the passage 430 of the measurement gas, thereby fixing the inner and outer covers 141 and 142 in the passage 433. Further, through the through-holes 140a and 150a of the inner and outer covers 140 and 150, the sensing portion 100a of the sensing element 100 is exposed to the measurement gas.

On those areas of the inner and outer surfaces of the housing 130 whish are exposed to the measurement gas, there is formed the oxide layer 132. The areas include the outer surface of a lower end portion of the housing 130, which is crimped onto the covers 140 and 150, and an area on the inner surface of the housing 130 extending from the lower end of the housing 130 to the seal member 190.

The signal lines 113 and 123 and power lines 164a and 164b are received in a casing 170. The upper end of the casing 170 is sealed by an insulative seal member 180, while the lower end of the same is fixed to a boss portion of the housing 130.

In the sensing element 100, a voltage is produced across the reference and measurement electrode layers 110 and 120 as a function of the difference in oxygen concentration between the reference and measurement gases. Accordingly, the concentration of oxygen in the measurement gas can be determined based on the voltage signal output from the sensing element 100.

In addition, it is also possible to determine the concentration of NOx in the measurement gas based on the voltage signal output from the sensing element 100.

The sensing element 100 is activated only when it is heated by either the measurement gas or the ceramic heater 160 to a high temperature of several hundred ° C.

At such a high temperature, if not properly designed, all the metal parts of the gas sensor 10 exposed to the measurement gas would be oxidized by the oxygen contained in the measurement gas, even when they are made of stainless steel. Accordingly, due to the oxygen consumption by oxidization of those parts, it would be impossible to accurately determine the oxygen concentration in the measurement gas.

However, in the present embodiment, all the metal parts of the gas sensor 10 exposed to the measurement gas have the respective oxide layers 121, 132, 141, and 151 previously formed on the surfaces thereof; thus, they are prevented from being oxidized by the oxygen contained in the measurement gas. Accordingly, it is possible to accurately determine the oxygen concentration in the measurement gas based on the voltage signal output from the sensing element 100. In other words, the gas sensor 10 according to the present embodiment has extra high accuracy and reliability.

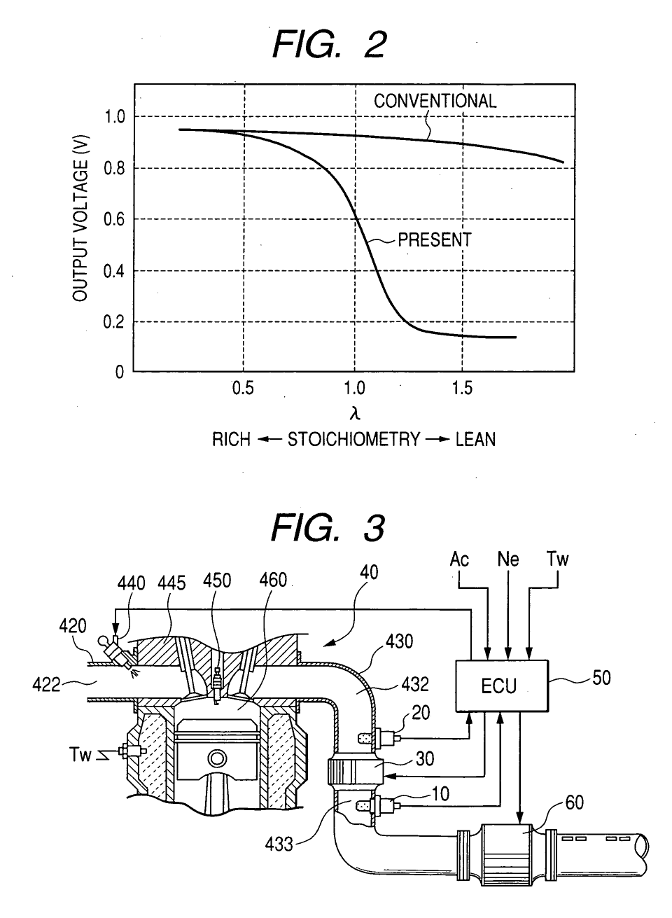

FIG. 2 shows the results of a comparative NO (nitric monoxide) sweep test between the gas sensor 10 according to the present embodiment and the conventional gas sensor 20b described previously.

As seen from FIG. 2, the conventional gas sensor 20b outputs an abnormal voltage signal representing that the output voltage does not change with the air/fuel ratio.

In comparison, the gas sensor 10 according to the present embodiment outputs an accurate voltage signal representing that the output voltage changes rapidly in the vicinity of the stoichiometry (i.e., λ=1).

FIG. 3 shows the disposition of the gas sensor 10 in an exhaust system of a motor vehicle.

As shown, a conventional gas sensor 20 is disposed in a passage 432 of the exhaust gas from an internal combustion engine 40 upstream of a three-way catalyst 30. The passage 432 is defined by an outlet pipe 430 of the engine 40. The gas sensor 20 outputs a voltage signal indicative of the oxygen concentration in the exhaust gas upstream of the three-way catalyst 30.

On the other hand, the gas sensor 10 of the present embodiment is disposed in a passage 433 of the exhaust gas downstream of the three-way catalyst 30. The gas sensor 10 outputs the voltage signal that indicates the oxygen concentration in the exhaust gas downstream of the three-way catalyst 30.

To an inlet pipe 420 of the engine 40, there is mounted a fuel injector 440 so as to protrude into an air passage 422 defined by the inlet pipe 420. Moreover, to a cylinder head 445, there is mounted a spark plug 450 so as to protrude into a combustion chamber 460.

An Engine Control Unit (ECU) 50 receives the voltage signals output from the gas sensors 20 and 10, a signal output from a speed meter and indicative of a rotational speed Ne of the engine 40, a signal output from a temperature sensor and indicative of a cooling water temperature Tw of the engine 40, and a signal output from a position sensor and indicative of an accelerator position Ac. Then, based on the received signals, the ECU 50 determines the air/fuel ratio. Thereafter, the ECU 50 controls, based on the determined air/fuel ratio, the combustion of the engine 40 by controlling, for example, the injection time of the fuel injector 440.

In addition, the voltage signal output from the gas sensor 10 of the present embodiment is used by the ECU 50 for correction of the determined air/fuel ratio, temperature control and deterioration detection of the three-way catalyst 30, and control of an exhaust gas purification device 60 provided downstream of the gas sensor 10.

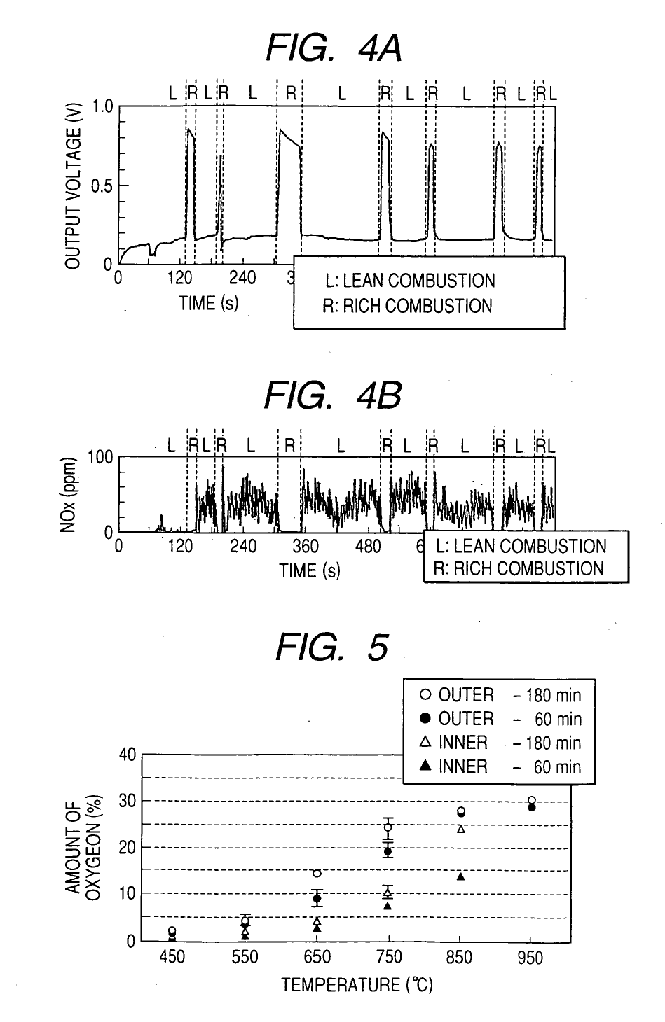

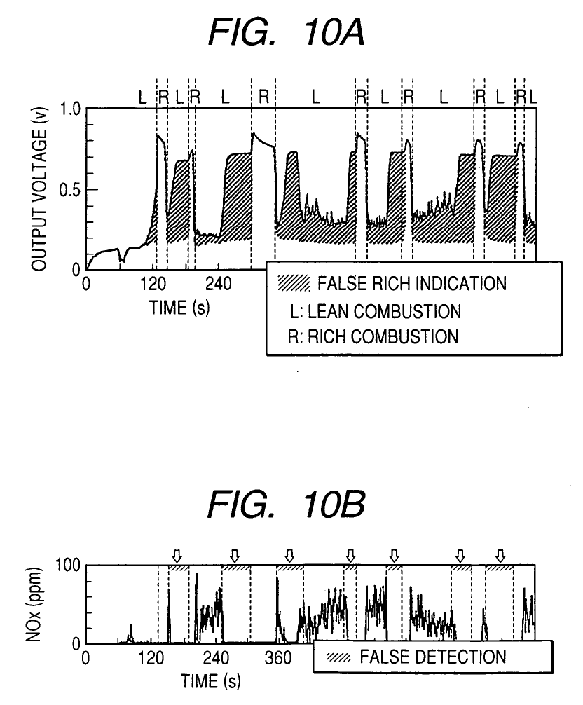

FIG. 4A shows the wave form of the voltage signal output from the gas sensor 10 of the present embodiment. It can be seen that unlike in FIG. 10A, there are no false rich indication regions in FIG. 4A.

FIG. 4B shows the NOx concentration in the exhaust gas detected based on the voltage signal output from the gas sensor 10. It can be seen that unlike in FIG. 10B, there are no false detection regions in FIG. 4B. In other words, it is possible to accurately determine the NOx concentration based on the voltage signal output from the gas sensor 10 of the present embodiment.

The inventors of the present invention have found not only the cause of the problem of false rich indication but also a solution to the problem through an experimental investigation.

In the investigation, to simulate possible changes in the inner and outer covers 140 and 150 in the passage 433 of the exhaust gas, samples of the inner and outer covers 140 and 150 were heat-treated in an atmosphere containing 3% oxygen at different temperatures for different times. In addition, each pair of samples of the inner and outer covers 140 and 150 was first assembled together and then heat-treated.

Further, for each of the heat-treated samples of the inner and outer covers 140 and 150, a surface analysis was made using EPMA (Electron Probe Micro Analyzer).

FIG. 5 shows the analysis results, where the horizontal axis indicates the temperature of heat treatment, and the vertical one indicates the amount of oxygen found on the surface. Moreover, in FIG. 5, the plots of “◯” indicate the analysis results on those samples of the outer cover 150 which are treated for 180 minutes; the plots of “ [symbol] ” indicate the analysis results on those samples of the outer cover 150 which are treated for 60 minutes; the plots of “Δ” indicate the analysis results on those samples of the inner cover 140 which are treated for 180 minutes; the plots of “▴” indicate the analysis results on those samples of the inner cover 140 which are treated for 60 minutes.

It can be seen from FIG. 5 that although all the samples were made of stainless steel (e.g., SUS 304, 310S, 316L, or 430 according to JIS), they were still oxidized when heat-treated at a temperature higher than or equal to 550° C. Further, it also can be seen from FIG. 5 that no considerable difference in oxygen amount was observed for each temperature between when heat-treated for 60 minutes and when heat-treated for 180 minutes.

Based on the above results, the inventors have concluded that the problem of false rich indication can be solved by heat-treating the inner and outer covers 140 and 150 in advance in an atmosphere containing oxygen at a high temperature.

Table 1 shows the effect of heat-treatment temperature on suppression of occurrence of the false rich indication, where the plots of “◯” indicate successful suppression, and the plots of “X” indicate failed suppression.

TABLE 1

| | TIME | | | | | | | |
|---|---|---|---|---|---|---|---|---|
| | (MIN) | 450° C. | 500° C. | 550° C. | 650° C. | 750° C. | 850° C. | 950° C. |
| INNER | 60 | X | X | ◯ | ◯ | ◯ | ◯ | ◯ |
| OUTER | 60 | X | X | ◯ | ◯ | ◯ | ◯ | ◯ |
| | 120 | X | X | ◯ | ◯ | ◯ | ◯ | ◯ |
| | 180 | X | X | ◯ | ◯ | ◯ | ◯ | ◯ |

It can be seen from Table 1 that to reliably prevent occurrence of the false rich indication, it is necessary to heat-treat the inner and outer covers 140 and 150 beforehand for a time of 60 minutes or longer at a temperature of 550° C. or higher, preferably 600° C. or higher.

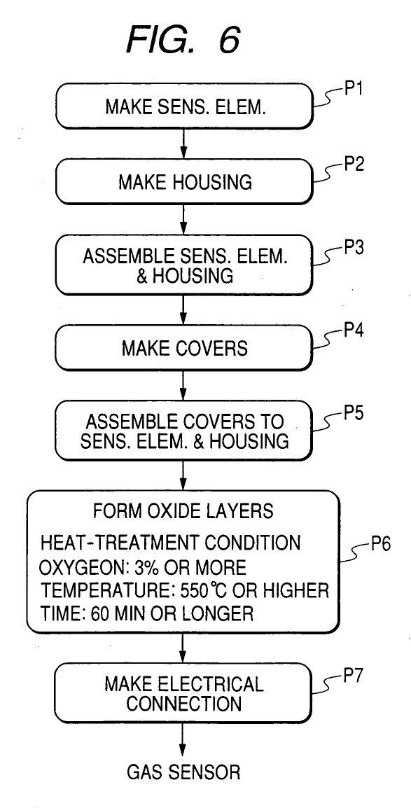

After having described the overall configuration of the gas sensor 10, a method of manufacturing the gas sensor 10 will be described with reference to FIG. 6.

At step P1, the sensing element 100 is made. Specifically, the solid electrolyte body 105 is first formed using an oxygen-ion conductive ceramic material including zirconia. Then, the reference electrode layer 110 and measurement electrode layer 120 are respectively formed on the inner and outer surfaces of the solid electrolyte body 105 using platinum.

At step P2, the housing 130 is made using a metal such as stainless steel.

At step P3, the sensing element 100 and housing 130 are assembled together so that the sensing element 100 is held in the housing 130 with the sensing portion 100a thereof protruding outside of the housing 130. Specifically, the sensing element 100 is fixed in the tubular housing 130 through the packing 190 and seal member 191. In addition, the ceramic heater 160 may also be assembled to the sensing element 100 in this step.

At step P4, the inner and outer covers 140 and 150 are made using a metal such as stainless steel.

At step P5, the inner and outer covers 140 and 150 are assembled to the sensing element 100 and housing 130 so that the covers 140 and 150 surround the sensing portion 100a of the sensing element 100 to allow the sensing portion 100a to be exposed to the measurement gas through the openings 140a and 150a of the covers 140 and 150.

At step P6, the assembly of the sensing element 100, housing 130, and inner and outer covers 140 and 150 is heat-treated to form the oxide layers 121, 132, 141, and 151. The heat treatment is performed in an atmosphere containing 3% or more oxygen, at a temperature of 550° C. or higher, and for a time of 60 minutes or longer.

At step P7, electrical connection is made for the signal lines 113 and 123 and power lines 164a and 164b using the connectors 112, 122, 163a, and 163b. Then, the casing 170 is mounted to the housing 130, and the open end (i.e., the upper end in FIG. 1) of the casing 170 is sealed with the seal member 180.

As a result, the gas sensor 10 of the present embodiment is obtained. In addition, it should be noted that the oxide layers 121, 132, 141, and 151 can also be formed at steps other than step P6. For example, those oxide layers can be formed at different times before step P5 or at the same time after step P7.

Using the above-described method, it is possible to easily form the oxide layers 121, 132, 141, and 151 on the surfaces of those parts of the gas sensor 10 which are to be exposed to the measurement gas.

Moreover, during the step of forming the oxide layers 121, 132, 141, and 151, residues of organic compounds used in the other steps, such as organic solvents and binders, can be completely eliminated from the gas sensor 10. Consequently, there will be no VOC (Volatile Organic Compounds) generated during operation of the gas sensor 10, thus reliably preventing the false rich indication from occurring due to VOC.

### Second Embodiment

This embodiment illustrates a gas sensor 10b which has almost the same configuration as the gas sensor 10 according to the first embodiment. Accordingly, only the difference in configuration therebetween will be described hereinafter.

As described previously, in the gas sensor 10 of the first embodiment, the sensing element 100 (more specifically, the solid electrolyte body 105 thereof) has the shape of a cup.

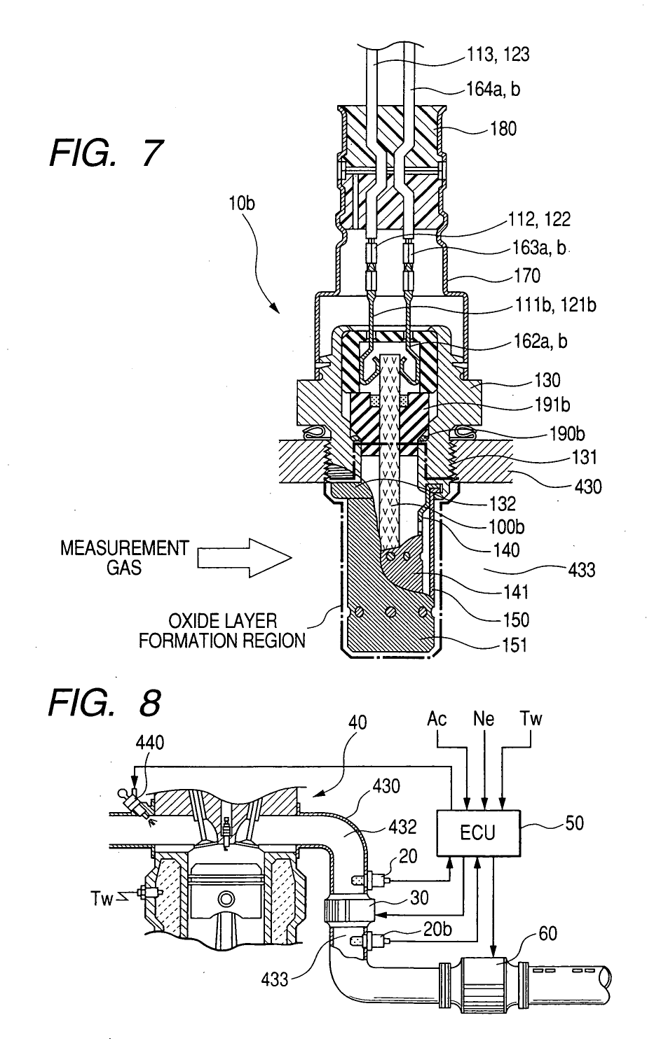

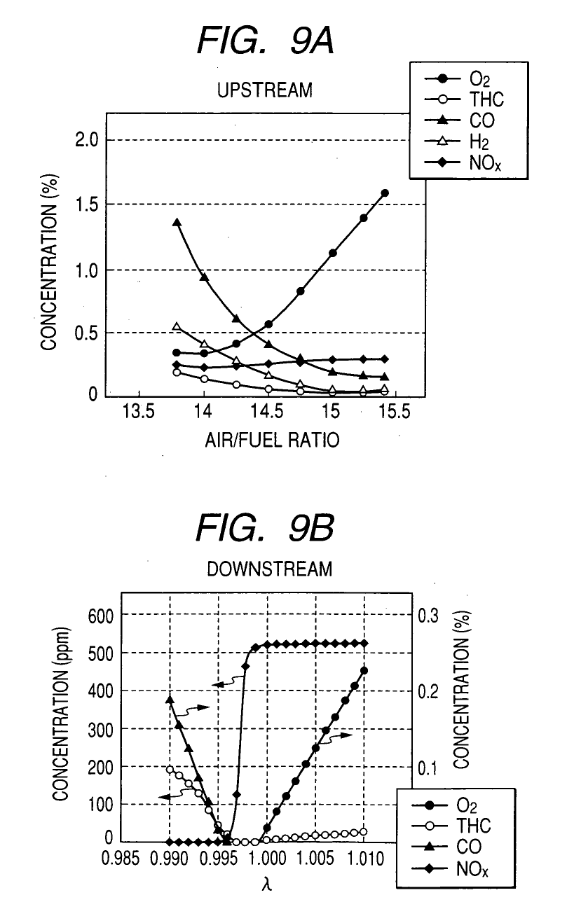

In comparison, as shown in FIG. 7, the gas sensor 10b of the present embodiment includes a laminated sensing element 100b.

The laminated sensing element 100b includes a solid electrolyte sheet that is conductive of oxygen ion and has an opposite pair of first and second major surfaces.

On the first major surface of the solid electrolyte sheet, there is formed a measurement electrode layer. Further, on the measurement electrode layer, there is formed a measurement gas diffusion layer.

On the second major surface of the solid electrolyte sheet, there is formed a reference electrode layer. Further, on the reference electrode layer, there is formed a reference gas chamber formation layer. Furthermore, on the reference gas chamber formation layer, there is formed, via an insulative layer, a ceramic heater layer for quick activation of the solid electrolyte sheet.

On an end portion (i.e., an upper end portion in FIG. 7) of the sensing element 100b, there are formed a measurement electrode terminal connected to the measurement electrode layer, a reference electrode terminal connected to the reference electrode layer, and a pair of heater terminals connected to a heating element provided in the ceramic heater layer.

The measurement electrode and reference electrode terminals are respectively connected, via connectors 111b and 121b, to the signal lines 113 and 123. The heater terminals are respectively connected, via the connectors 162a and 162b, to the power lines 164a and 164b.

The measurement electrode layer is exposed to the measurement gas that is introduced thereto via the measurement gas diffusion layer; the reference electrode layer is exposed to the reference gas that is introduced thereto via a reference gas chamber formed in the reference gas chamber formation layer.

In the sensing element 100b, a voltage is produced across the measurement and reference electrode layers as a function of the difference in oxygen concentration between the measurement and reference gases. Accordingly, the concentration of oxygen in the measurement gas can be determined based on the voltage signal output from the sensing element 100b.

In addition, it is also possible to determine the concentration of NOx in the measurement gas based on the voltage signal output from the sensing element 100b.

While the above particular embodiments of the invention have been shown and described, it will be understood by those skilled in the art that various modifications, changes, and improvements may be made without departing from the spirit of the invention.

For example, in the previous embodiments, the gas sensors 10 and 10b have a double-cover structure consisting of the inner and outer covers 140 and 150.

However, the gas sensors 10 and 10b may have a single-cover structure or other multiple-cover structures.

Moreover, in the previous embodiments, the inner and outer covers 140 and 150 have the shape of a cup to enclose the sensing portion of the sensing element; further, they respectively have a plurality of through-holes 140a and 150a for introducing the measurement gas to the sensing element.

However, the inner and outer covers 140 and 150 also may have other shapes and gas passages in other forms for introducing the measurement gas to the sensing element.

Furthermore, gas sensors according to the invention can be used in passages of exhaust gases from engines of any type, such as gasoline, diesel, and liquefied natural gas engines.

What is claimed is:

1. A gas sensor comprising:
a sensing element that generates a signal indicative of an oxygen concentration in a measurement gas;
a housing that holds therein the sensing element with a portion of the sensing element protruding outside of the housing;
a metal cover that surrounds the portion of the sensing element and is to be exposed the measurement gas, the metal cover having formed therein a gas passage through which the sensing element is also to be exposed to the measurement gas; and
an oxide layer that is formed on at least a surface of the metal cover.

2. The gas sensor as set forth in claim 1, wherein the measurement gas is exhaust gas from an internal combustion engine, and
the gas sensor is disposed, in a passage of the exhaust gas, downstream of a three-way catalyst for purifying the exhaust gas.

3. The gas sensor as set forth in claim 1, wherein the sensing element comprises:
a solid electrolyte body that is conductive of oxygen ion and has first and second surfaces;
a measurement electrode that is provided on the first surface of the solid electrolyte body so as to be exposed to the measurement gas; and
a reference electrode that is provided on the second surface of the solid electrolyte body so as to be exposed to a reference gas introduced into the gas sensor,
wherein the oxide layer is also formed on a surface of the measurement electrode of the sensing element.

4. A method of manufacturing a gas sensor, the method comprising:
preparing a sensing element for generating a signal indicative of an oxygen concentration in a measurement gas;
preparing a housing;
assembling the sensing element and housing together so that the sensing element is held in the housing with a portion thereof protruding outside of the housing;
preparing a metal cover that is to be exposed to the measurement gas and has formed therein a gas passage;
assembling the metal cover to the sensing element and housing so that the metal cover surrounds the portion of the sensing element but allows the sensing element to be exposed to the measurement gas through the gas passage; and
forming an oxide layer on at least a surface of the metal cover through a heat treatment in an atmosphere containing oxygen.

5. The method as set forth in claim 4, wherein the atmosphere contains 3% or more oxygen.

6. The method as set forth in claim 4, wherein the heat treatment is performed at a temperature not lower than a temperature of the measurement gas.

7. The method as set forth in claim 4, wherein the heat treatment is performed at a temperature of 600° C. or higher.
